(19) United States
(12) Patent Application Publication
(10) Pub. No.: US 2011/0264884 A1
(43) Pub. Date: Oct. 27, 2011

(54) DATA STORAGE DEVICE AND METHOD OF OPERATING THE SAME

(75) Inventor: Sung-joo Kim, Hwaseong-si (KR)

(73) Assignee: Samsung Electronics Co., Ltd, Suwon-si (KR)

(21) Appl. No.: 13/069,672

(22) Filed: Mar. 23, 2011

(30) Foreign Application Priority Data
Apr. 27, 2010 (KR) 10-2010-0039105

(51) Int. Cl. G06F 12/02

(52) U.S. Cl. 711/170; 711/E12.002

(57) ABSTRACT

A data storage device includes a storage media storing data and a controller that receives a de-allocation command and performs the de-allocation command according to a size of a de-allocation region. When a size of the de-allocation region is larger than a minimum erase unit of the storage media, the controller performs a first de-allocation operation to erase a part of the de-allocation region, an operation to notify the host of a completion of the de-allocation command after the first de-allocation operation, and a second de-allocation operation to erase the rest of the de-allocation region.

### CROSS-REFERENCE TO RELATED APPLICATIONS

This application claims the benefit of priority, under 35 U.S.C. §119, of Korean Patent Application No. 10-2010-0039105 filed Apr. 27, 2010, the entire contents of which are incorporated by reference herein.

### BACKGROUND

1. Field of the Invention

Exemplary embodiments relate to an electronic device, and more particularly, relate to a data storage device and an operation method thereof.

2. Description of the Related Art

Recently, the computing environment has become ubiquitous, resulting in usage of computing systems anytime and everywhere. For example, usage of portable electronic devices such as cellular phones, MP3, PMP, digital cameras, notebook computers, etc. has increased dramatically in a very short time. General portable electronic devices may have a data storage device which uses a memory device in order to store data. A user device, such as a portable electronic device, may include a host device and a data storage device.

A data storage device using a memory device may be a device having any type of storage media. The data storage device using a memory device may include a standardized interface such as a Parallel ATA (PATA) interface, a Serial ATA (SATA), an USB memory interface, an SD card interface, an MMC card interface, an Embedded MMC (eMMC) card interface, a CF card interface, etc. in order to interface with a host. A storage media of the data storage device may include any one of non-volatile memory devices such as a flash memory device, a phase change random access memory, etc.

A data storage device using a memory device has the advantages of excellent stability and endurance because no mechanical driving unit exists, an access speed is quite fast, and power consumption is low.

### SUMMARY

The present general inventive concept is directed to a data storage device to advantageously perform a de-allocation process to increase performance of the data storage device and a corresponding host device.

Additional aspects and utilities of the present general inventive concept will be set forth in part in the description which follows and, in part, will be obvious from the description, or may be learned by practice of the present general inventive concept.

Features and/or utilities of the present general inventive concept may be realized by a data storage device comprising a storage media storing data and a controller receiving a de-allocation command and performing the de-allocation command according to a size of a de-allocation region. When a size of the de-allocation region is larger than a minimum erase unit of the storage media, the controller performs a first de-allocation operation erasing a part of the de-allocation region, an operation notifying the host a completion of the de-allocation command after the first de-allocation operation, and a second de-allocation operation erasing the rest of the de-allocation region after notifying the host.

Additional features and/or utilities of the present general inventive concept may be realized by a data storage device comprising a storage media storing data and a controller configured to control the storage media by receiving a de-allocation command from a host and comparing a size of a de-allocation requested region with a size of a minimum erase unit of the storage media. When a size of the de-allocation requested region is larger than a size of the minimum erase unit of the storage media, the controller erases a part of the de-allocation requested region, notifies the host a de-allocation completion after the erasing, configures an erase bitmap corresponding to an un-erased region of the de-allocation requested region, and performs a de-allocation operation according to the erase bitmap after notifying of the completion.

Still other features and/or utilities of the present general inventive concept may be realized by an operating method of a data storage device which includes a storage media storing data and a controller configured to control the storage media. The operating method may include receiving a de-allocation command and a de-allocation region from a host, comparing a size of the de-allocation region with a size of a minimum erase unit of the storage media, performing a de-allocation operation according to a comparison result, and notifying the host that a de-allocation operation is completed. The performing a de-allocation operation according to a comparison result may include erasing the de-allocation region wholly when a size of the de-allocation region is larger than a size of the minimum erase unit of the storage media and performing a first de-allocation operation for erasing a part of the de-allocation region and a second de-allocation operation for erasing the rest of the de-allocation region when a size of the de-allocation region is less than a size of the minimum erase unit of the storage media.

Features and/or utilities of the present general inventive concept may also be realized by a method of de-allocating data including receiving a command to de-allocate data storage in a device having a minimum erase unit corresponding to a minimum amount of data to be erased per de-allocation operation, determining whether the size of data to be de-allocated is greater than the minimum erase unit, and when the size of data to be de-allocated is smaller than the minimum erase unit, performing one de-allocation operation and transmitting an acknowledgement, and when the size of the data to be de-allocated is greater than the minimum erase unit, performing a plurality of de-allocation operations and transmitting an acknowledgement before completing the plurality of de-allocation operations.

Performing a plurality of de-allocation operations may include, before performing a first de-allocation operation of the plurality of de-allocation operations, generating de-allocation management data to indicate storage locations corresponding to each of the plurality of de-allocation operations other than the first de-allocation operation.

Generating de-allocation management data may include marking an erase bitmap.

Performing a plurality of de-allocation operations may include transmitting the acknowledgement after completing only a first de-allocation operation of the plurality of de-allocation operations.

The method may further include determining whether the size of the data to be de-allocated is an exact multiple of the minimum erase unit, and when it is determined that the size of the data to be de-allocated is an exact multiple of the minimum erase unit, transmitting the acknowledgement before starting any of the plurality of de-allocation operations.

The method may further include waiting to perform at least the plurality of de-allocation operations other than a first of the plurality of de-allocation operations until it is determined that no command is received from a host device.

Performing at least one of the one de-allocation operation and the plurality of de-allocation operations may include determining whether a section of data storage corresponding to the minimum erase unit and including data to be de-allocated may include data that is not to be de-allocated, and copying the data that is not to be de-allocated to a data storage location other than the data storage locations to be de-allocated.

Features and/or utilities of the present general inventive concept may also be realized by a data storage device including storage media to store data, and a controller to control the storage of data in the storage media by receiving a command to de-allocate a storage region of the storage media, determining whether the storage region to be de-allocated is greater than a predetermined storage size, and if the storage area is greater than the predetermined storage size, performing a plurality of de-allocation operations to de-allocate the storage region and transmitting an acknowledgement of de-allocation before completing the plurality of de-allocation operations.

The storage media may be incapable of over-writing stored data without first performing an erasing operation.

The predetermined storage size may be a minimum storage size at which the storage media erases data.

When the controller determines that the storage region to be de-allocated is not greater than the predetermined storage size, the controller may perform one de-allocation operation corresponding to a storage block of the predetermined storage size and transmits the acknowledgement of de-allocation after performing the one de-allocation operation.

Before performing a first de-allocation operation of the plurality of de-allocation operations, the controller may generate de-allocation management data to indicate storage locations corresponding to each of the plurality of de-allocation operations other than a first de-allocation operation.

The controller may include memory, and the controller may store the de-allocation management data in the memory.

The de-allocation management data may be an erase bitmap, and the controller may mark the erase bitmap to indicate storage locations to be de-allocated.

The controller may transmit the acknowledgement after completing only the first de-allocation operation of the plurality of de-allocation operations.

The controller may determine whether the size of the data to be de-allocated is an exact multiple of the predetermined storage size, and when it is determined that the size of the data to be de-allocated is an exact multiple of the minimum erase unit, the controller may transmit the acknowledgement before starting any of the plurality of de-allocation operations.

The controller may wait to perform at least the plurality of de-allocation operations other than the first of the plurality of de-allocation operations until it is determined that the controller is performing no operation in response to a command from a host device.

In performing at least one of the one de-allocation operation and the plurality of de-allocation operations, the controller may determine whether a section of data storage corresponding to the predetermined storage size and including data to be de-allocated may include data that is not to be de-allocated, and the controller may copy the data that is not to be de-allocated to a data storage location other than the data storage locations to be de-allocated.

Features and/or utilities of the present general inventive concept may also be realized by an electronic device including a host to control operations of the electronic device, and a data storage device to receive a command from the host to de-allocate a storage region of the storage media, to determine whether the storage region to be de-allocated is greater than a predetermined storage size, and if the storage area is greater than the predetermined storage size, to perform a plurality of de-allocation operations to de-allocate the storage region and transmitting an acknowledgement of de-allocation before completing the plurality of de-allocation operations.

### BRIEF DESCRIPTION OF THE DRAWINGS

The above and other objects and features of the present general inventive concept will become apparent from the following description with reference to the following figures, wherein like reference numerals refer to like parts throughout the various figures unless otherwise specified, and wherein:

FIG. 1A is a block diagram showing an electronic system according to an exemplary embodiment of the present general inventive concept.

FIG. 1B is a block diagram showing an electronic device according to another embodiment of the present general inventive concept.

FIG. 2 is a block diagram showing a controller in a data storage device illustrated in FIG. 1.

FIG. 3 is a block diagram showing a flash translation layer according to an exemplary embodiment of the present general inventive concept.

FIG. 4 is a diagram showing an operation of deleting a file via a file system of a host.

FIG. 5 is a flow chart showing an operation of a data storage device according to an exemplary embodiment of the present general inventive concept when a de-allocation command is provided.

FIGS. 6A to 6B are diagrams showing a de-allocation process when de-allocated data is less in size than an erase unit of a flash memory device.

FIGS. 7A and 7B are diagrams showing a de-allocation process when de-allocated data is more in size than an erase unit of a flash memory device.

FIGS. 8A and 8B are flow charts showing an operation of a data storage device according to an exemplary embodiment of the present general inventive concept.

FIG. 9 is a block diagram showing a computing system including a data storage device according to an exemplary embodiment of the present general inventive concept.

### DETAILED DESCRIPTION OF THE EMBODIMENTS

The inventive concept is described more fully hereinafter with reference to the accompanying drawings, in which embodiments of the inventive concept are shown. This inventive concept may, however, be embodied in many different forms and should not be construed as limited to the embodiments set forth herein. Rather, these embodiments are provided so that this disclosure will be thorough and complete, and will fully convey the scope of the inventive concept to those skilled in the art. In the drawings, the size and relative sizes of layers and regions may be exaggerated for clarity. Like numbers refer to like elements throughout.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath”, “below”, “lower”, “under”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” or “under” other elements or features would then be oriented “above” the other elements or features. Thus, the exemplary terms “below” and “under” can encompass both an orientation of above and below. The device may be otherwise oriented (rotated 90 degrees or at other orientations) and the spatially relative descriptors used herein interpreted accordingly. In addition, it will also be understood that when a layer is referred to as being “between” two layers, it can be the only layer between the two layers, or one or more intervening layers may also be present.

The terminology used herein is for the purpose of describing particular embodiments only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It will be understood that when an element or layer is referred to as being “on”, “connected to”, “coupled to”, or “adjacent to” another element or layer, it can be directly on, connected, coupled, or adjacent to the other element or layer, or intervening elements or layers may be present. In contrast, when an element is referred to as being “directly on,” “directly connected to”, “directly coupled to”, or “immediately adjacent to” another element or layer, there are no intervening elements or layers present.

In the specification and claims, when the terms “first,” “second,” etc. are used to refer to physical components, the term is used as an identifier only, and does not indicate an order of use or formation of the physical components. Thus a “first” object could alternatively be referred to as a “second” object, and vice versa. However, when the terms “first,” “second,” etc. are used to refer to operations, such as de-allocation operations, then the terms refer to an order in which the operations are performed. In such a case, a “first” operation is performed before any additional operations.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

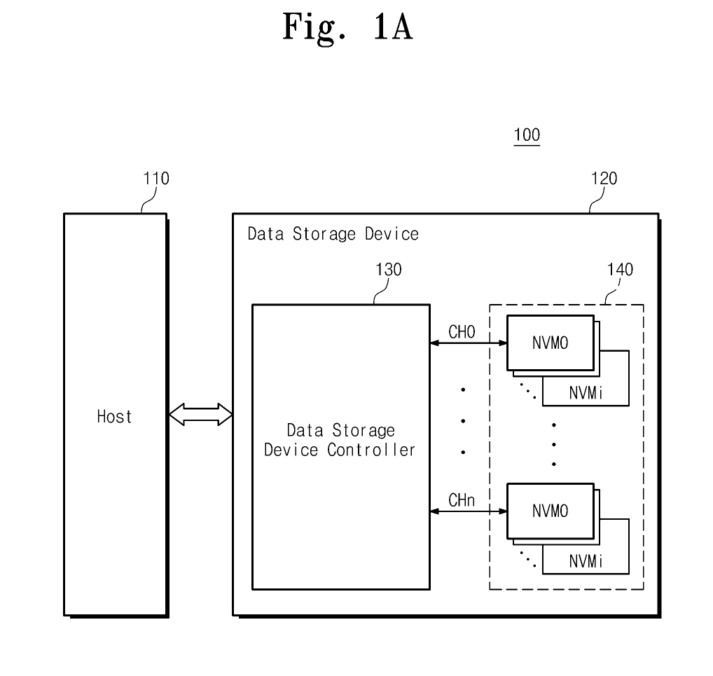

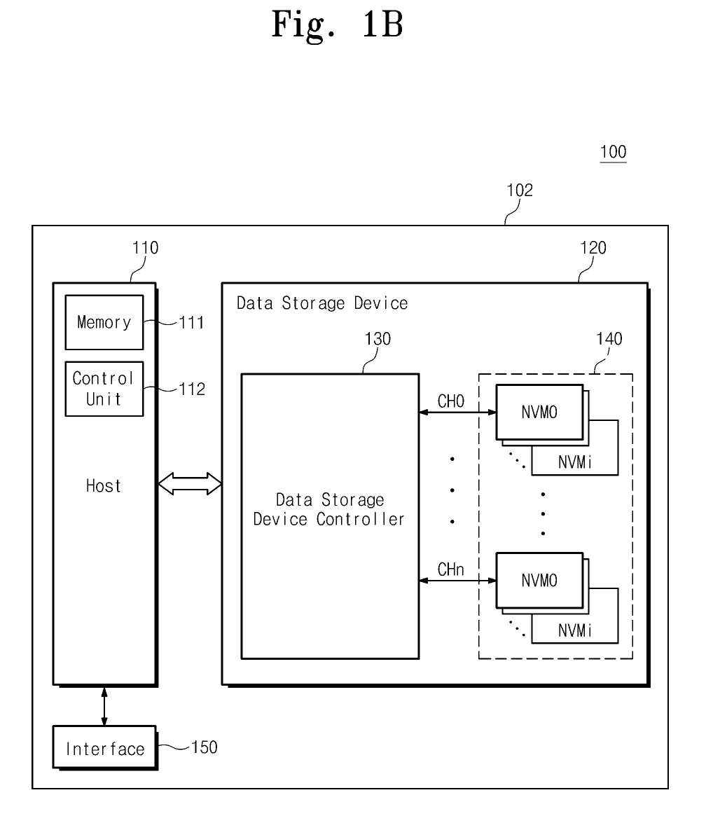

FIG. 1A is a block diagram showing an electronic system or device 100 according to an exemplary embodiment of the present general inventive concept.

Referring to FIG. 1A, an electronic system 100 includes a host 110 and a data storage device 120. The host 110 is configured to control the data storage device 120. The host 110, for example, may include portable electronic devices such as cellular phones, PDA, PMP, MP3 players, digital cameras, digital camcorders, etc. and/or electronic devices such as personal/portable computers, HDTV, navigation systems, etc. The data storage device 120 operates responsive to the control of the host 110. The data storage device 120 retains stored data even at power-off. The data storage device 120, for example, may be a memory card, such as an SD card, a CF card, an MMC, an eMMC, etc. an USB memory device, or a Solid State Drive (SSD). That is, the data storage device 10 uses a memory device as a storage media.

The data storage device 120 may be a separate device from the host 110 that is connected to the host 110, or the data storage device 120 may be fixed within the body of the host 110 to communicate with a control unit of the host 110. For example, if the host 110 is a portable electronic device such as a cell phone, the data storage device 120 may be a device connected to a port of the cell phone or in wireless communication with the cell phone, or the data storage device 120 may be a storage device that is fixed within the body of the cell phone. For purposes of explanation, the present specification refers to the data storage device 120 as being connected to the host 110 and receiving commands from the host 110.

As illustrated in FIG. 1B, the entire electronic system 100 may be a single device enclosed within an outer shell 102, such as a portable electronic device, and each of the host 110 and the data storage device 120 may be components of the portable electronic device. For example, the host 110 may include at least one control unit 112 including a processor and logic to drive the user device 100, and may also include one or more interfaces 150 to receive input from a user or other devices to control the electronic device 100. The host 110 may also include memory 111 other than the data storage device 120, such as cache memory or other memory to store data in addition to the data stored by the data storage device 120. The user device 100 need not be directly controlled by a user, but may also be a server or other computing device that may be programmed by a user to interact with the data storage device 120.

The data storage device 120 includes a data storage device controller 130 (hereinafter, referred simply to as a controller) and a storage media 140. The controller 130 controls the storage media 140 in response to a request from the host 110. For example, the controller 130 controls read, write, and erase operations of the storage media 140 in response to an access request from the host 110.

The controller 130 is connected to the storage media 140 via a plurality of channels CH1 to CHn. The storage media 140 includes a plurality of non-volatile memory devices. Each of the channels CH1 to CHn is connected to a plurality of non-volatile memories NVM0 to MVMi (i being an integer). The number of non-volatile memories connected to each channel is capable of being implemented in any configuration. The storage media 140, for example, may be made up of a plurality of flash memory devices. But, it is well understood that the storage media 140 made up of other non-volatile memory devices instead of the flash memory device. For example, the storage media 140 may be made up of any one of a phase change RAM (PRAM), a Ferroelectric RAM (FRAM), a Magnetic RAM (MRAM), etc.

As a non-volatile memory device in the storage media 140, a flash memory device can store single bit data or multi bit data per cell. A memory cell storing single bit data is called a Single Level Cell (SLC), and a memory cell storing multi level data is called a Multi Level Cell (MLC). The SLC may have any one of an erase state and a program state, depending upon its threshold voltage. The MLC may have any one of an erase state and a plurality of program states, depending upon its threshold voltage.

The user device 100 includes an operating system (OS) which may consist of software to drive the user device 100, a file system, a user application program, and a data-storage-device-driving firmware which may be software to drive the data storage device 120. The data-storage-device-driving firmware may be a Flash Translation Layer (FTL), for example.

The file system may be selected according to an operating system of the user device 100. For example, in the event that an operating system of the user device 100 is a Disk Operating System (DOS) or a Windows-based operating system, there may be used a File Allocation Table (FAT) file system, a Virtual FAT (VFAT) file system, an extended FAT (exFAT) file system, a New Technology File System (NTFS), or the like. In another embodiment, a UNIX File System (UFS) is used as the operating system of the user device 100 in case of a UNIX-based operating system, or a LINUX file system (extended file system: EXT) is used as the operating system of the user device 100 in case of a LINUX-based operating system.

Files used by the host 110 may be managed by a file system of the user device 100. For example, a file may be stored in the data storage device 120 in a sector or cluster unit according to the control of the host 110. A file stored in the data storage device 120 is sent to the host 110 in a sector or cluster unit according to a request from the host 110. A “sector” refers to the least or smallest data management unit that is accessed by an application program and has a size of 512 bytes. A cluster is the least, or smallest, storage space unit allocated to a file and is determined according to the capacity of a storage device. In other words, the application program may request that one or more sectors be transmitted between the host 110 and the data storage device 120, and the application program may not request transmission of segments of data smaller than a “sector.” Similarly, the data storage device 120 may perform read or write operations from/to memory in segments of at least a “cluster.”

The host 110 may notify the data storage device 120 of information associated with an address region which is de-allocated by a file system. That is, the host 110 notifies the data storage device 120 of information related to unnecessary data (or, files) of data (or, files) stored in the data storage device 120. This may be accomplished by sending a specific command (hereinafter, referred to as a de-allocation command) to the data storage device 120. The unnecessary data (or, files) refers to data which need not be retained or stored any more. The determination as to which data and/or files are unnecessary may be made by a user or by a computer program based on any variety of criteria, including type of file, frequency of use, amount of storage space remaining, whether duplicate data exists, etc. The de-allocation command may be called a trim command. The de-allocation command may include address information (for example, logical address information de-allocated by the file system). The address information included in the de-allocation command may be referred to as a de-allocation address.

If the de-allocation command is provided from the host 110, the data storage device 120 may revise mapping information (or, meta data) corresponding to the de-allocation address. The data storage device 120 is capable of completing a de-allocation operation by revising the mapping information (or, meta data). Alternatively, if the de-allocation command is received from the host 110, the data storage device 120 may erase data stored at a region of the data storage device 120 corresponding to the de-allocation address. The erase operation is carried out according to a size of a de-allocation address space (i.e., a size of de-allocated data).

The data storage device 120 according to an exemplary embodiment of the present general inventive concept deletes unnecessary data, which need not be retained or stored any more, among data stored in the data storage device 120, via the de-allocation operation. Deleting the data allows the data storage device 120 to not perform an operation of managing unnecessary data, which improving the operating speed of the data storage device 120. Since the de-allocation operation is carried out according to a size of de-allocated data, the data storage device 120 reduces a response time related to the de-allocation command. Further, the data storage device 120 reduces a management resource (for example, a working memory space) since an erase bitmap is configured in an erase unit, which will be more fully described below.

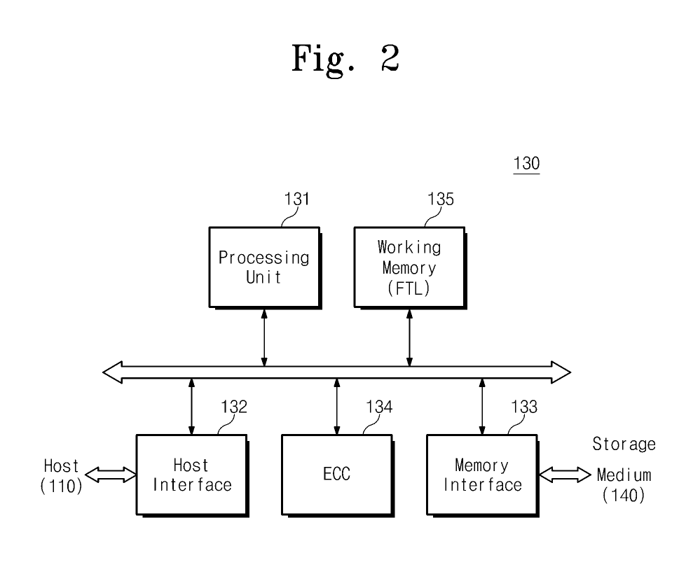

FIG. 2 is a block diagram showing a controller in a data storage device illustrated in FIG. 1.

Referring to FIG. 2, a controller 130 includes a processing unit 131, a host interface 132, a memory interface 133, an ECC unit 134, and a working memory 135. But, it is well understood that elements of the controller 130 are not limited to the above-described elements. For example, the controller 130 may further comprise a ROM for storing code data necessary for an initial booting operation, a buffer memory controller for controlling a buffer memory device, and the like.

The processing unit 131 includes a central processing unit or a micro-processor. The processing unit 131 controls an overall operation of the controller 130. The processing unit 131 is configured to drive firmware to control the controller 130. The firmware is driven after it is loaded into the working memory 135.

The host interface 132 provides an interface between the host 110 and the controller 130. The host 110 and the controller 130 may be interconnected each other via various standardized interfaces. Alternatively, the host 110 and the controller 130 may be interconnected each other via some interfaces of various standardized interfaces. Standardized interfaces include an Advanced Technology Attachment (ATA) interface, a Serial ATA (SATA) interface, an external SATA (e-SATA) interface, a Small Computer Small Interface (SCSI) interface, a Serial Attached SCSI (SAS) interface, a Peripheral Component Interconnection (PCI) interface, a PCI express (PCI-E) interface, an IEEE 1394 interface, a Universal Serial Bus (USB) interface, a Secure Digital (SD) card interface, a Multi Media Card (MMC) interface, an embedded MMC (eMMC) interface, a Compact Flash (CF) card interface, and the like.

The memory interface 130 provides an interface between the controller 130 and the storage medium 140. For example, data processed by the processing unit 131 is stored in the storage media 140 via the memory interface 133. Data stored in the storage media 140 is provided to the processing unit 131 via the memory interface 133. The memory interface 133 includes a memory controller for controlling the storage media 140. Further, the memory interface 133 is able to provide an interface between the controller and a buffer memory device (not shown).

The ECC unit 134 recovers data damaged due to various factors. For example, the ECC unit 134 is configured to detect errors in data read from the storage media 140 and to correct erroneous data thus detected. In FIG. 2, the ECC unit 134 is illustrated to be as an element of the controller 130. But, the ECC unit 134 can be provided to be as an element of the storage media 140.

The working memory 135 stores firmware to control the controller 130 and meta data needed to drive the firmware. The firmware and the meta data stored in the working memory 135 are driven by the processing unit 131. The working memory 135 may include at least one of a cache memory, DRAM, SRAM, PRAM, a flash memory, and the like. According to exemplary embodiments of the general inventive concept, a Flash Translation Layer (FTL) is stored in the working memory 135.

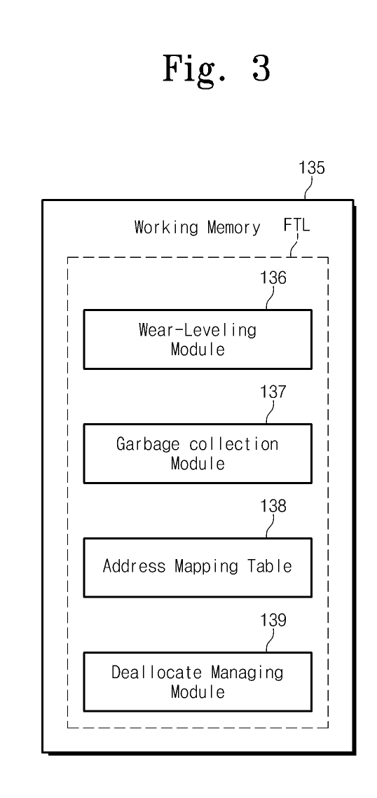

FIG. 3 is a block diagram showing a flash translation layer according to an exemplary embodiment of the inventive concept.

Due to structural characteristics, if the storage media 140 (refer to FIG. 1A) is a flash memory device, the storage media 140 performs a read or write operation in a page unit and an erase operation in a block unit. A “page” includes a plurality of memory cells, and a “block” (or, referring to as a memory block) includes a plurality of pages. An erase operation must be performed on a memory cell before new data may be stored in the memory cell. The above-described characteristics of the flash memory device necessitate managing read, write, and erase operations thereof. A Flash Translation Layer (FTL) is a system software (or, firmware) which is developed according to provide these functions of managing the read, write, and erase operations. The FTL is loaded on a working memory 135 (refer to FIG. 2) and driven by a processing unit 131 (refer to FIG. 2).

Referring to FIG. 3, the FTL loaded on the working memory 135 includes a plurality of modules: a wear-leveling module 136, a garbage collection module 137, an address mapping table 138, and a de-allocation managing module 139. But, elements of the FTL are not limited to the above-described elements. For example, the FTL may further comprise a sudden power-off managing module for providing the unexpected power-off, a bad block managing module for managing defective blocks, and the like.

The wear-leveling module 136 manages the wear-level on blocks of a flash memory device. Memory cells of the flash memory device undergo aging due to write and erase operations. Aged memory cells, that is, worn-out memory cells, may cause defects such as physical defects. The wear-leveling module 136 manages the erase-write cycle number of blocks so as to be leveled, thus preventing first blocks from being worn out faster than second blocks.

The garbage collection module 137 adjusts blocks in which fragmented data is stored. The flash memory device necessitates a collection task because its erase unit is larger than its write unit. The collection task may be accomplished by collecting fragments of continuous data, separated at different positions, at the same address using any free block(s) at need. In other words, the garbage collection module 138 performs a plurality of write operations and a plurality of erase operations to perform the collection task to collect fragmented data at the same address.

In the event that a host 110 (refer to FIG. 1A) accesses a data storage device 120 (refer to FIG. 1A), it provides a logical address to the data storage device 120. A controller 130 translates the logical address into a physical address of a flash memory device. That is, the FTL manages address translation data for address translation, which is managed via the address mapping table 138.

In accordance with exemplary embodiments of the present general inventive concept, the FTL includes the de-allocation managing module 139. The de-allocation managing module 139 performs a de-allocation operation in response to a de-allocation command from the host 110. The de-allocation managing module 139 judges a de-allocation address provided from the host 110 in order to perform the de-allocation operation. The de-allocation managing module 139 determines a timing when the de-allocation operation is carried out, depending upon the judgment result. That is, the de-allocation managing module 139 may erase data corresponding to the de-allocated address without delay or generate management data of the de-allocated address. This management data may be stored using an erase bit map or a de-allocation table, for example. During an idle state that a command is not received from the host 110, the de-allocation managing module 139 additionally performs the de-allocation operation with reference to the erase bit map or the de-allocation table.

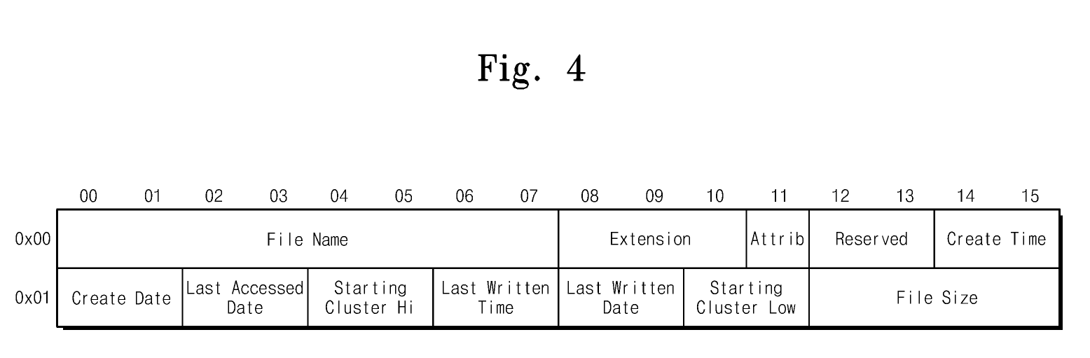

FIG. 4 is a diagram showing an operation of deleting a file via a file system of a host.

Data used by a user device 100 (refer to FIG. 1A) is stored in a data storage device 120 (refer to FIG. 1A) by a directory or file format. A host 110 utilizes a file system to manage a large amount of data efficiently. Among various file systems, in particular, a FAT file system is widely used in applications such as a computer system, a memory card, a USB memory, a digital camera, and the like.

Referring to FIG. 4, there is illustrated a directory entry structure which is generated in order for the FAT file system to manage files. A directory entry has a size of 32 bytes. The directory entry is formed of a file name, an extension, an attribute, create date and time, a last accessed date, last written date and time, a starting cluster, and a file size.

In the event that a directory or file is deleted, the file system changes a value of the first byte of a directory entry of the deleted directory or file. If a value of the first byte of a directory entry is changed into ‘0xE5’, the directory entry is deleted. Afterwards, the file system initializes a FAT entry in a file allocation table into ‘0x00’. In this case, since the file system manages its meta data (for example, a file allocation table), real data stored in a region of the data storage device 120 is not deleted. The host 110 according to exemplary embodiments of the present general inventive concept provides the data storage device 120 with information on an address de-allocated by the file system. The address de-allocated by the file system may be generated due to deleting of a directory or file. The deleting of the directory or file may occur as a result of a user input, an application executed by the host 110, or another function performed by the host 110. The information on an address de-allocated by the file system may be sent as the host 110 transfers a de-allocation command to the data storage device 120. The data storage device 120 deletes data stored at a corresponding address fully according to the de-allocation command.

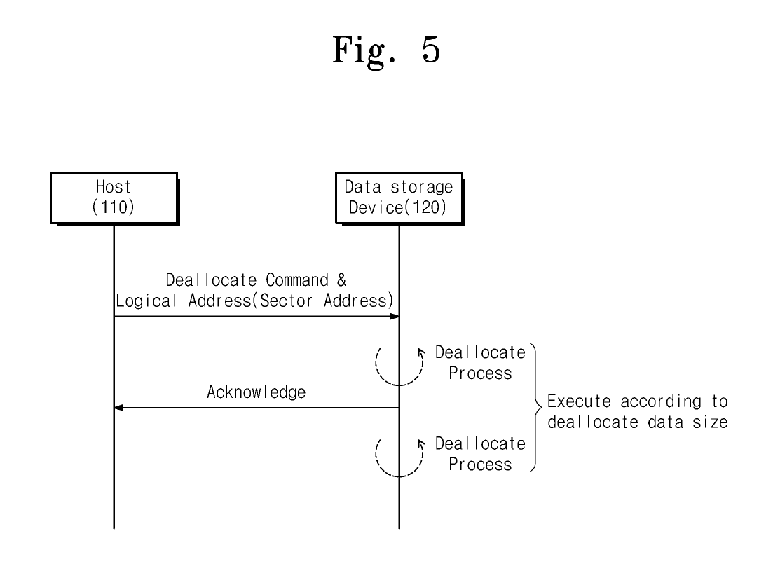

FIG. 5 is a flow chart showing an operation of a data storage device according to an exemplary embodiment of the inventive concept when a de-allocation command is provided.

A host 110 notifies a data storage device 120 of information on an address region de-allocated by a file system. The file system may be a software implementation that represents the hardware data storage locations, and the file system may be stored in or executed by the host 110 or by another element of the user device 100. The information on an address region de-allocated by the file system is a logical address region which is recognized as an empty region due to deletion of the file system. The host 110 provides information on the de-allocated region by sending the de-allocation command. The de-allocation command is provided together with logical address information (that is, a sector address) on the de-allocated region. There may be provided a start logical address of the de-allocated region and a size (or, a last logical address) thereof. The size of the de-allocated region may be expressed by the number of sector addresses.

The data storage device 120 receives the de-allocation command and the de-allocation address from the host 110 to perform a de-allocation process on the de-allocation address region. The de-allocation process includes moving valid data in the de-allocation address region and deleting the de-allocation address region. The de-allocation address region is carried out according to a size of the de-allocation address region provided from the host 110. The size of the de-allocation address region may be identical to that of data de-allocated by the file system.

If data de-allocated by the file system of the host 110 is smaller in size than an erase unit (for example, a block unit) of a flash memory device 140 (refer to FIG. 1) in the data storage device 120, the data storage device 120 erases the de-allocated region without delay. After an erase operation is completed, the data storage device 120 notifies the host 110 that the de-allocation process is ended.

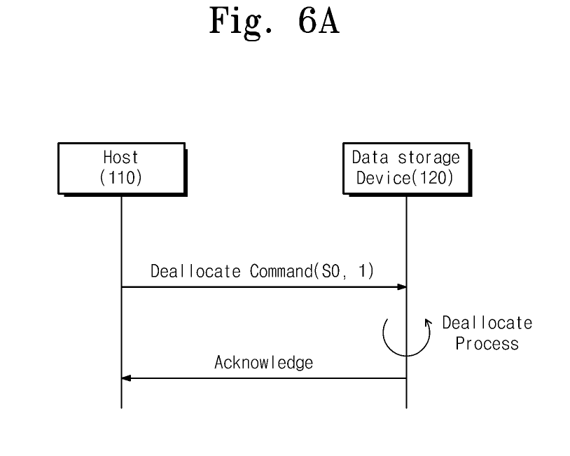

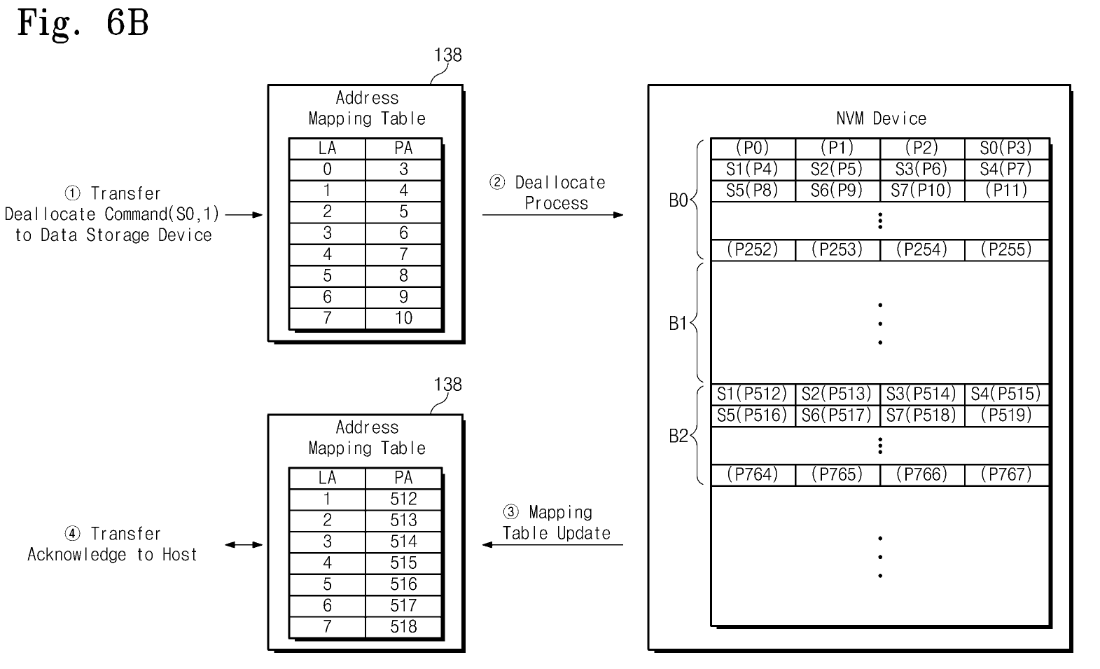

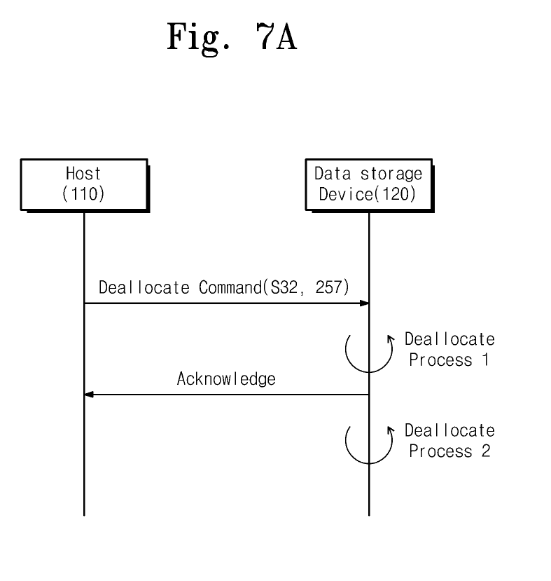

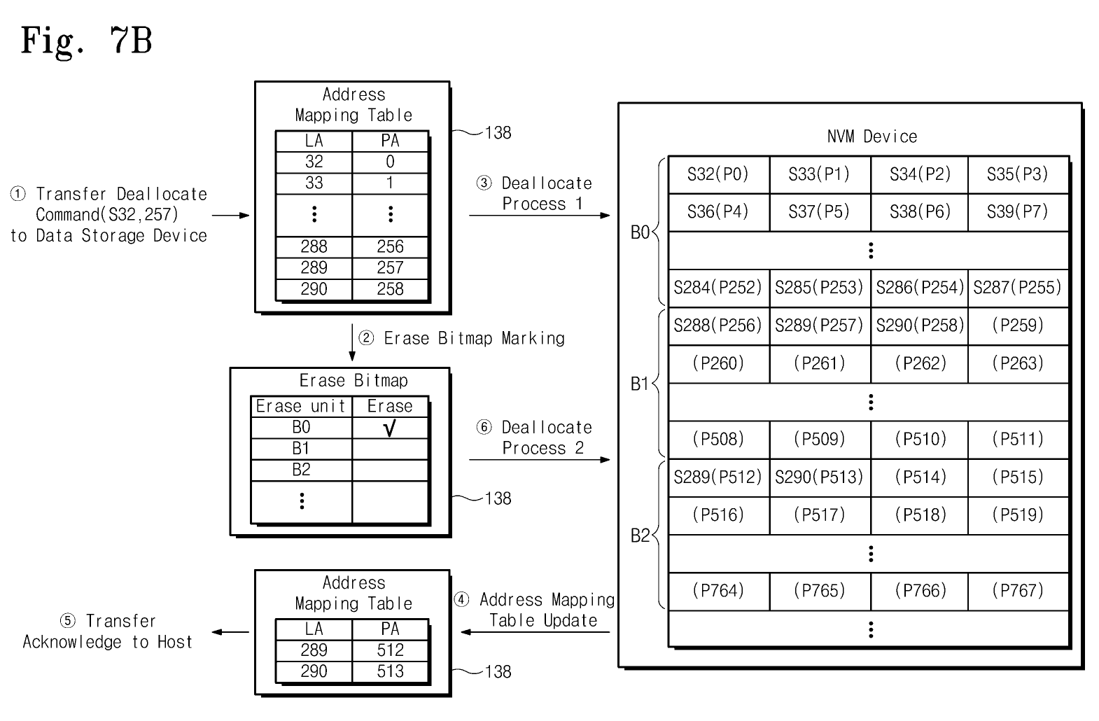

If data de-allocated by the file system of the host 110 is greater in size than an erase unit (for example, a block unit) of the flash memory device 140 (refer to FIG. 1) in the data storage device 120, the de-allocation process is divided and performed. That is, the data storage device 120 marks a corresponding block at an erase bitmap and erases a remaining de-allocation region less than a block size. If an erase operation is completed, the data storage device 120 notifies the host 110 that the de-allocation process is ended. Afterwards, during an idle time, the data storage device 120 performs an erase operation on a block marked at the erase bitmap. The de-allocation process will be more fully described with reference to FIGS. 6A, 6B, 7A, and 7B.

FIGS. 6A and 6B are diagrams showing a de-allocation process when de-allocated data is smaller in size than an erase unit of a flash memory device.

Referring to FIG. 6A, a de-allocation command and a de-allocation address are provided from a host 110. For example, the de-allocation address may be formed of a start logical address of a de-allocated region and a size thereof. In FIG. 6A, there is illustrated an example that the de-allocation address corresponds to a sector S0, that is, one sector. In the present specification, it is assumed that one sector has a size of 512 bytes and a block has a size of 128 kilobytes, however a sector and block size may vary according to the specifications of a particular system. Since the sector has a size of 512 bytes and a block has a size of 120 kilobytes, a segment of de-allocated data is smaller in size than a block. Accordingly, a data storage device 120 immediately erases the de-allocated data and then notifies the host 110 that a de-allocation process is completed. Below, the de-allocation process will be more fully described with reference to FIG. 6B.

The host 110 provides the de-allocation command and the de-allocation address to the data storage device 120. The following may be described under the assumption that an address de-allocated by a file system of the host 110 corresponds to one sector S0, that one sector has a size of 512 bytes, and that a block is formed of 64 pages and has a size of 128 kilobytes.

The data storage device 120 immediately performs a de-allocation process since de-allocated data corresponds to one sector (that is, 512 bytes). The data storage device 120 refers to an address mapping table 138 for translating a logical address provided from the host 110 into a physical address of the flash memory device 140. As illustrated in the address mapping table 138, the de-allocated sector S0 is mapped to a physical address P3.

Since a flash memory device does not support an overwrite function on a region where data is stored, the data storage device 120 must actually erase a region corresponding to the physical address P3. Further, since an erase operation of the flash memory device is performed in a block unit, the data storage device 120 may erase a block B0 including the region corresponding to the physical address P3. As illustrated in FIG. 6B, the block B0 includes not only a sector S0 to be erased but also valid data, that is, valid sectors S1 to S7. Accordingly, the data storage device 120 copies and rearranges valid sectors S1 to S7 into a working memory 135 (refer to FIG. 2). The data storage device 120 stores the rearranged sectors S1 to S7 in a free block B2. The rearranged sectors S1 to S7 may be stored in regions of the block B2 corresponding physical addresses P512 to P518, respectively.

Upon completion of the above-described copy operation, the data storage device 120 erases the block B0. After the erase operation is ended, the data storage device 120 updates an address mapping table 138 for mapping the valid sectors S1 to S7. Afterwards, the data storage device 120 notifies the host 110 that the de-allocation process is completed.

FIGS. 7A and 7B are diagrams showing a de-allocation process when de-allocated data is greater in size than an erase unit of a flash memory device.

Referring to FIG. 7A, a de-allocation command and a de-allocation address are provided from a host 110. For example, the de-allocation address may be formed of a start logical address of a de-allocated region and a size thereof. In FIG. 7A, the de-allocation address corresponds to 257 sectors S32 to S288. A size of data de-allocated by a file system of the host 110 is (128 kilobytes+512 bytes) (that is, 257 sectors). That is, the de-allocated data is greater in size than a block (128 kilobytes) of a flash memory device in the data storage device 120. Accordingly, the data storage device 120 divides the de-allocation operation into multiple parts corresponding to multiple blocks to be de-allocated and performs the de-allocation process. Notifying of completion of the de-allocation process may be carried out before the de-allocation process is entirely completed. Below, this will be more fully described with reference to FIG. 7B.

The host 110 provides a de-allocation command a de-allocation address to the data storage device 120. As described in FIG. 7B, an address de-allocated by the file system of the host 110 corresponds to 257 sectors S32 to S288. It is assumed that one page has a size of 2 KB and a block is formed of 64 pages and has a size of 128 KB.

Since the de-allocated data has a 257-sector size (that is, 128 KB+512 B), the data storage device 120 divides the de-allocation process into the first de-allocation process and the second de-allocation process. Prior to performing the de-allocation process, the data storage device 120 refers to an address mapping table for converting a logical address provided from the host 110 into a physical address of the flash memory device 140. The data storage device 120 maps a physical address in which data of a de-allocated region is stored, based on the address mapping table. An actual physical block corresponding to the de-allocated address is selected according to the mapping result. If data of the de-allocated region is stored entirely within a block, the data storage device 120 marks whether a corresponding block is erased. After marking, the data storage device 120 performs the first de-allocation process.

An erase bitmap is marked to indicated whether or not a block should be erased. The data storage device 120 configures the erase bitmap to manage a region to be erased. Accordingly, the erase bitmap is formed of block units. If an erase operation is carried out, a region marked at the erase bitmap may indicate an empty data storage region, for example, a region in which data can be stored. The erase bitmap may be temporarily stored in a working memory 135 (refer to FIG. 2). Further, the erase bitmap temporarily stored in the working memory 135 may be stored periodically in the flash memory device 140. Since the erase bitmap is formed of a block unit, there may be reduced a storage space of the working memory 135 storing the erase bitmap.

In another exemplary embodiment, a de-allocation table may be marked to determine whether to erase a block. The de-allocation table may be configured such that a de-allocation address corresponds to a physical address of the flash memory device 140. But, if the de-allocation table is configured such that a de-allocation address corresponds to a physical address of the flash memory device 140, there increases a size of a management resource (for example, a size of occupying a working memory) for managing the de-allocation table. That is, the performance may be lowered in case of a data storage device (for example, a card-type data storage device) a working memory of which is small in size or capacity. Accordingly, the de-allocation table may be formed of a block unit of the flash memory device 140. When the de-allocation table that the de-allocation table is marked to determine whether to erase a block, the de-allocation table may be configured independently from the erase bitmap.

Returning to refer to FIG. 7B, since data of the de-allocated region is stored in the block B0 wholly, the data storage device 120 marks whether a block B0 is erased or not, at the erase bitmap. If a mark related to a previous operation exists at the erase bitmap, the erase bitmap is updated. After marking at the erase bitmap whether a block B0 is erased or not, the data storage device 120 performs the first de-allocation process on a remaining de-allocated physical address region except for the block B0.

The remaining de-allocated sector S288 is mapped to a physical address P256 via the address mapping table. Since a flash memory device does not support an overwrite function on a region where data is stored, the data storage device 120 must actually erase the de-allocated physical address P256. Further, since an erase operation of the flash memory device is performed in a block unit, the data storage device 120 may erase the block B1 including the region corresponding to the physical address P256.

The block B1 includes not only a sector S288 to be erased, but also valid sectors S289 and S290. The valid sectors S289 and S290 are sectors which store valid data and don't undergo de-allocation. Accordingly, the data storage device 120 copies and rearranges the valid sectors S289 and S290 in a working memory 135. The data storage device 120 stores the rearranged sectors S289 and S290 in physical address regions P512 and P513 of a block B2.

After copying of the sectors S289 and S290, the data storage device 120 erases the block B1. That is, the data storage device 120 performs the first de-allocation process in order to erase the block B1. If the first de-allocation process is completed, the data storage device 120 updates the address mapping table for mapping the sectors S289 and S290 which store valid data and don't undergo de-allocation. Afterwards, the data storage device 120 notifies the host 110 that the de-allocation process is completed.

After notifying the host 110 that the de-allocation process is completed, the data storage device 120 performs the second de-allocation process. In an exemplary embodiment, the second de-allocation process may be carried out during an idle time when a command is not received from the host 110. or when other data retrieval or storage operations are not being performed according to commands from the host 110. The second de-allocation process may be carried out based on the erase bitmap. That is, the second de-allocation process may include erasing the block B0 marked at the erase bitmap. In FIG. 7B, there is illustrated an example that one block (that is, B0) is erased. It is well understood that the de-allocated region to be erased according to the second de-allocation process can include N blocks (N being an integer of 2 or more). If the erase operation is ended, an actual physical address region corresponding to a logical address de-allocated by a file system may become an empty region (for example, a region capable of storing data). Since the second de-allocation process is carried out after notifying completion of the de-allocation process, the performance of a user device 100 (refer to FIG. 1A) is not affected.

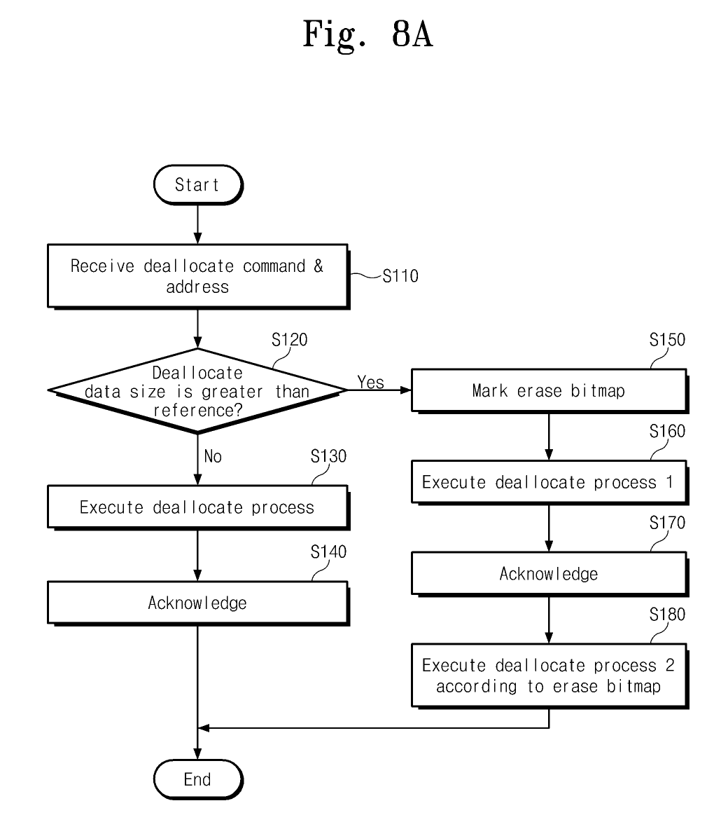

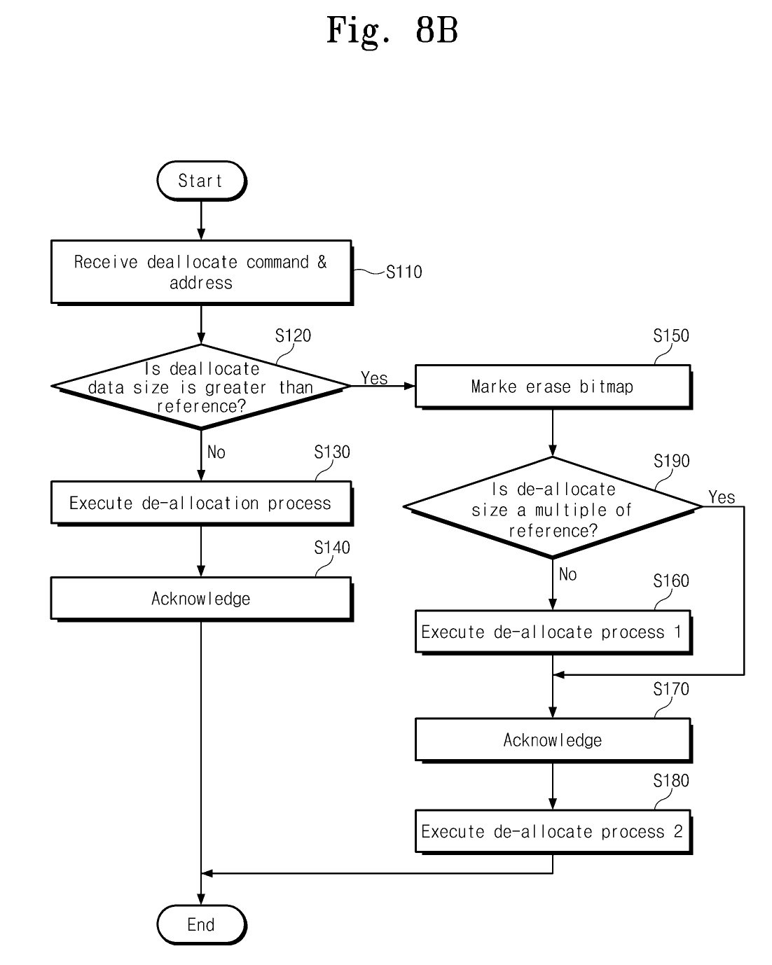

FIG. 8A is a flow chart showing an operation of a data storage device according to an exemplary embodiment of the present general inventive concept.

In operation S110, a host 110 (refer to FIG. 1A) provides a data storage device 120 (refer to FIG. 1A) with information on an address de-allocated by a file system. The address de-allocated by the file system is a logic address which corresponds to a space recognized to be empty due to deletion by the file system. The host 110 provides the information on the de-allocated address/region by sending a de-allocation command. The de-allocation command may be provided with logical address information (that is, a sector address) on the de-allocated region.

The data storage device 120 performs a de-allocation process on the de-allocation address region in response to the de-allocation command and the de-allocation address provided from the host 110. The de-allocation process is carried out according to a size of the de-allocated address region provided from the host 110. A size of the de-allocated address region may be identical to that of data de-allocated by the file system. In operation S120, the data storage device 120 judges whether a size of the de-allocated data is larger than a reference value. The reference value may be an erase unit of a storage media 140 (refer to FIG. 1A) of the data storage device 120.

If it is determined in operation S120 that a size of the de-allocated data is not greater than the reference value, the data storage device 120 performs a de-allocation process without delay in operation S130. That is, the data storage device 120 immediately erases the de-allocated address region. The de-allocation process may include copying valid data in the de-allocated address region and erasing the de-allocated address region. When the erase operation is completed, in operation S140, the data storage device 120 notifies the host 110 that the de-allocation process is completed.

If a size of the de-allocated data is greater than the reference value, that is, a block size of a flash memory device 140, then a de-allocation process is divided and performed in operations S160 and S180. Specifically, the data storage device 120 maps an actual physical address corresponding to the de-allocation address via an address mapping table, and an actual physical block is selected according to the mapping result. If data of the de-allocated region is stored entirely in a block, the data storage device 120 marks an erase bitmap in operation S150 to indicate whether a corresponding block is erased. The erase bitmap may be a table generated to manage whether a block is erased or not.

In operation S160, the data storage device 120 performs the first de-allocation process on a remaining physical address region except for a block marked at the erase bitmap. In other words, the data storage device 120 marks on the erase bitmap S150 one or more blocks to erase in a later operation to be performed after acknowledging completion of the de-allocation process in operation S170. The data storage device 120 then performs the first de-allocation process of operation S160 on a block that is not marked on the erase bitmap.

The first de-allocation process includes copying valid data in the de-allocated address region and erasing the de-allocated address region. When the first erase operation is ended, in operation S170, the data storage device 120 notifies the host 110 that the de-allocation process is completed. Afterwards, in operation S180, the data storage device 120 performs the second de-allocation process, and any additional de-allocation processes according to the marked erase bitmap. The second de-allocation process may be carried out during an idle time when no command is received from the host 110. The second de-allocation process performs an erase operation on a block marked at the erase bitmap. Once the second erase operation is completed, an actual physical address region corresponding to the de-allocation logical address may become an empty region (for example, a region capable of storing data).

The data storage device 120 deletes data, which is not retained or stored any more, among data (or, files) stored in the data storage device 120, via the de-allocation operation. The de-allocation operation is carried out according to a size of the de-allocated address region provided from the host 110. A size of the de-allocated address region may be identical to a size of data de-allocated by the file system. Accordingly, the data storage device 120 does not perform an operation of managing unnecessary data, which improves an operating speed of a user device 100. Further, the data storage device 120 reduces a response time on the de-allocation command since it determines an execution timing of the de-allocation operation according to a size of de-allocated data and only de-allocates a first block before transmitting an acknowledgement of the de-allocation operation. Still further, the data storage device 120 reduces a size of a resource (for example, an occupied space of a working memory) since it configures an erase bitmap in an erase unit.

In addition, FIG. 8B illustrates an embodiment in which, if the size of the data-to-be-de-allocated is exactly a multiple of the minimum erase unit of the data storage device 120, so that no sector including good data needs to be moved, operation S160 may be skipped, and the acknowledgement of operation S170 may be sent immediately after marking the erase bitmap in operation S150. In other words, the process of FIG. 8B is similar to FIG. 8A, except, after the erase bitmap is marked in operation S150, it is determined in operation S190 whether the size of the de-allocation data is a multiple of the reference. If so, operation S160 is skipped, since no good data needs to be re-located, and the acknowledgement may be sent immediately after operation S190.

The above-described embodiments allow for increased performance of an electronic device by performing a de-allocation operation in an idle time. The idle time may be a time in which no operation is being performed by the data storage device controller 130 for which the host 110 is awaiting a response. For example, a request to perform an action such as reading data from memory or changing the location of data in memory may require a response, such as an acknowledgement or a transmission of address data, program data, or other non-address data to the host. According to the present general inventive concept, the storage device controller 130 may receive a de-allocation command from the host 110, record any data storage locations to be de-allocated, transmit an acknowledgement to the host, and then perform any remaining de-allocation operations at a time in which no outstanding commands from the host 110, such as a data request, require transmitting a response to the host 110.

In the specification and claims, the de-allocation acknowledgement, which may also be referred to merely as an acknowledgement, is a communication sent to the host, or to the device that transmitted the de-allocation command, to tell the host that the de-allocation operation is complete. According to the present general inventive concept, this acknowledgement may be transmitted even before the de-allocation process is completed, because the storage sections that are to be de-allocated have been recorded to be de-allocated during the idle time. By transmitting the acknowledgement before the de-allocation is completed, the host or other command-transmitting device, may perform other operations instead of waiting for the completion of the de-allocation process.

While the present general inventive concept includes performing the de-allocation processes during an idle time, the processes may also be performed when necessitated by a command from the host. For example, if the host 110 transmits a command to write data to the specific physical address locations that are marked in the erase bitmap to be de-allocated, the storage device controller 130 may then immediately perform the de-allocation process of the requested physical addresses without waiting for an idle time.

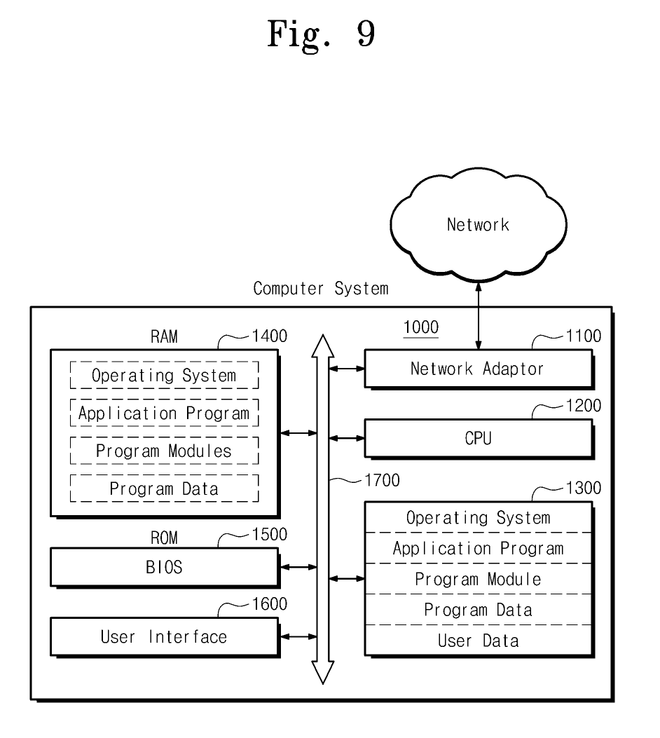

FIG. 9 is a block diagram showing a computing system including a data storage device according to an exemplary embodiment of the inventive concept.

A computing system 1000 includes a network adaptor 1100, a CPU 1200, a data storage device 1300, a RAM 1400, a ROM 1500, and a user interface 1600 which are electrically connected with a system bus 1700.

The network adaptor 1100 provides an interface between the computing system 1000 and external networks. The CPU 1200 performs an overall operation for driving an operating system or an application program resident on the RAM 1400. The data storage device 1300 stores data which the computing system 1000 necessitates. For example, are in the device 1300 stored an operating system for driving the computing system 1000, various program modules, program data, user data, and the like.

The RAM 1400 is used as a working memory of the computing system 1000. Upon booting, on the RAM 1400, are loaded an operating system, application program, various program modules, and program data necessary for driving programs. The ROM 1500 stores the Basic Input/Output System (BIOS) which is activated before the operating system is driven. A user exchanges data with the computing system via the user interface 1600. Further, the computing system 100 can include a battery, a modem, etc. Although not shown, the computing system further comprises an application chipset, a Camera Image Processor (CIS), a mobile DRAM, and the like.

As described above, the data storage device 1300 may be formed of an SSD, an MMC, an SD card, a micro-SD card, a memory stick, an ID card, a PCMCIA card, a chip card, an USB card, a smart card, a CF card, or the like.

The above-disclosed subject matter is to be considered illustrative, and not restrictive, and the appended claims are intended to cover all such modifications, enhancements, and other embodiments, which fall within the true spirit and scope. Thus, to the maximum extent allowed by law, the scope is to be determined by the broadest permissible interpretation of the following claims and their equivalents, and shall not be restricted or limited by the foregoing detailed description.

1. A data storage device comprising:
a storage media to store data; and
a controller to receive a de-allocation command and to perform the de-allocation command according to a size of a de-allocation region,
wherein when a size of the de-allocation region is greater than a minimum erase unit of the storage media, the controller performs a first de-allocation operation to erase a part of the de-allocation region, an operation notifying the host a completion of the de-allocation command after the first de-allocation operation, and a second de-allocation operation to erase the rest of the de-allocation region.

2. The data storage device of claim 1, wherein when a size of the de-allocation region is greater than a minimum erase unit of the storage media, the controller generates management data corresponding to the de-allocation region.

3. The data storage device of claim 2, wherein the controller erases the de-allocation region with reference to the management data during an idle time.

4. The data storage device of claim 1, wherein the controller moves valid data of an erase unit of the storage media in which the de-allocation region is included.

5. The data storage device of claim 1, wherein a size of the de-allocation region erased by the first de-allocation operation is smaller than the minimum erase unit of the storage media, and a size of the de-allocation region erased by the second de-allocation operation is a multiple of the minimum erase unit of the storage media.

6. The data storage device of claim 1, wherein the controller generates management data corresponding to a region not erased by the first de-allocation operation, and the second de-allocation operation is carried out according to the management data.

7. The data storage device of claim 1, wherein when a size of the de-allocation region is smaller than a minimum erase unit of the storage media, the controller erases the de-allocation region.

8. The data storage device of claim 7, wherein prior to an erase operation, the controller moves valid data of an erase unit of the storage media in which the de-allocation region is included.

9. The data storage device of claim 1, wherein the de-allocation region corresponds to a logical address of data deleted by a file system of the host.

10. The data storage device of claim 1, wherein the data storage device is formed of a solid state drive (SSD).

11. The data storage device of claim 1, wherein the data storage device is formed of an embedded multimedia card (eMMC).

12. A data storage device comprising:
a storage media to store data; and
a controller configured to control the storage media, to receive a de-allocation command from a host, and to compare a size of a de-allocation requested region with a size of a minimum erase unit of the storage media,
wherein when a size of the de-allocation requested region is greater than a size of the minimum erase unit of the storage media, the controller performs a first de-allocation operation to erase a part of the de-allocation requested region, notifies the host of a completion of a de-allocation after erasing the part of the de-allocation request region, configures an erase bitmap corresponding to an un-erased region of the de-allocation requested region, and performs a second de-allocation operation according to the erase bitmap after notifying the host of the completion.

13. The data storage device of claim 12, wherein a size of the de-allocation requested region erased before notifying of de-allocation completion is smaller than a size of the minimum erase unit of the storage media, and a size of the de-allocation requested region erased after notifying of de-allocation completion is identical to or more than a size of the minimum erase unit of the storage media.

14. The data storage device of claim 12, wherein the controller erases the de-allocation requested region with reference to the erase bitmap during an idle time when no command is received from the host.

15. The data storage device of claim 12, wherein the de-allocation requested region is a logical address region of data deleted by a file system of the host.

16. An operating method of a data storage device which includes a storage media to store data and a controller configured to control the storage media, the operating method comprising:
receiving a de-allocation command and a de-allocation region from a host;
comparing a size of the de-allocation region with a size of a minimum erase unit of the storage media;
performing a de-allocation operation according to a comparison result; and
notifying the host that a de-allocation operation is completed,
wherein the performing a de-allocation operation according to a comparison result comprises:
erasing the de-allocation region when a size of the de-allocation region is smaller than a size of the minimum erase unit of the storage media; and
performing a first de-allocation operation for erasing a part of the de-allocation region and a second de-allocation operation for erasing the rest of the de-allocation region when a size of the de-allocation region is greater than a size of the minimum erase unit of the storage media.

17. The operating method of claim 16, wherein the notifying the host that a de-allocation operation is completed is performed prior to the second de-allocation operation.

18. The operating method of claim 16, further comprising, when a size of the de-allocation region is greater than a size of the minimum erase unit of the storage media, making erase managing data corresponding to the de-allocation region.

19. The operating method of claim 18, wherein the making erase managing data corresponding to the de-allocation region is carried out before the first de-allocation operation and the second de-allocation operation are performed.

20. The operating method of claim 19, wherein the second de-allocation operation is carried out with reference to the erase managing data.

21.-39. (canceled)
